(19) United States
(12) Patent Application Publication
(10) Pub. No.: US 2023/0093866 A1
(43) Pub. Date: Mar. 30, 2023

(54) INFORMATION PROCESSING DEVICE, INFORMATION PROCESSING METHOD, AND PROGRAM

(71) Applicant: SONY GROUP CORPORATION, Tokyo (JP)

(72) Inventors: Honoka OZAKI, Tokyo (JP); Kentaro IDA, Tokyo (JP); Takuya IKEDA, Tokyo (JP)

(73) Assignee: SONY GROUP CORPORATION, Tokyo (JP)

(21) Appl. No.: 17/913,672

(22) PCT Filed: Mar. 9, 2021
(86) PCT No.: PCT/JP2021/009219

§ 371 Date: Sep. 22, 2022

(30) Foreign Application Priority Data
Apr. 15, 2020 (JP) 2020-072750

(51) Int. Cl. H04N 23/695; H04N 23/611; G06T 7/20; G06T 7/70; G06V 40/20

(52) U.S. Cl. CPC H04N 23/695; H04N 23/611; G06T 7/20; G06T 7/70; G06V 40/20; G06T 2207/30196; G06T 2207/30241

(57) ABSTRACT

A prediction calculation unit calculates a predicted position from a trajectory of a tracking target. A drive calculation unit calculates an imaging direction of an imaging unit that images the tracking target, the imaging direction in which the predicted position is included in an angle of view of the imaging unit when the predicted position calculated by the prediction calculation unit deviates from the angle of view. Therefore, for example, the number of movements can be reduced as compared with the case where the imaging direction always follows the tracking target so that the tracking target is at the center of the angle of view, and the tracking operation can be performed efficiently. Further, when the predicted position is within the angle of view, the imaging direction of the imaging device is fixed even if the position of the tracking target moves, so that the position of the tracking target can be detected with high accuracy.

### TECHNICAL FIELD

The present technology relates to an information processing device, an information processing method, and a program and enables an imaging device to efficiently perform tracking operations.

### BACKGROUND ART

Conventionally, an imaging device has been used to automatically track a target object. For example, in PTL 1, the predicted position of an object after a predetermined designated time is calculated based on the detection result of the object, and when an imaging device is directed toward the predicted position, the designated time is different depending on the moving speed of the object obtained from the detection result.

### CITATION LIST

### Patent Literature

[PTL 1] JP 2019-68182 A.

### SUMMARY

### Technical Problem

By the way, when the method disclosed in PTL 1 is used, since the object is always tracked at a designated time, the driving operation is performed even when the imaging device does not need to move.

Therefore, an object of the present technology is to provide an information processing device, an information processing method, and a program that enable an imaging device to efficiently perform a tracking operation.

### Solution to Problem

A first aspect of the present technology provides an information processing device including: a prediction calculation unit that calculates a predicted position from a trajectory of a tracking target; and a drive calculation unit that calculates an imaging direction of an imaging unit that images the tracking target, the imaging direction in which the predicted position is included in an angle of view of the imaging unit when the predicted position calculated by the prediction calculation unit deviates from the angle of view.

In the present technology, the prediction calculation unit calculates the predicted position from the trajectory of the drawing position with respect to the tracking target, for example, the image display surface. The drive calculation unit calculates the imaging direction of the imaging unit that images the tracking target, the imaging direction in which the predicted position is, for example, a desired position within the angle of view of the imaging unit when the predicted position calculated by the prediction calculation unit deviates from the angle of view. The desired position is, for example, the center of the angle of view, within a predetermined range with respect to the center of the angle of view, a position where a plurality of candidate predicted positions calculated by the prediction calculation unit from the trajectory of the tracking target are within the angle of view, or a position where the current position of the tracking target and the predicted position calculated by the prediction calculation unit are within the angle of view.

The prediction calculation unit may calculate a plurality of candidate predicted positions from the trajectory of the tracking target and calculate the predicted position based on the plurality of candidate predicted positions, and may correct the calculated predicted position act the position of the tracking target after the predicted position is calculated. The prediction calculation unit may correct the predicted position based on the recognition result from the user recognition unit that recognizes the user who moves the tracking target.

The prediction calculation unit may be able to change the time interval for calculating the predicted position within a preset range. For example, the drive calculation unit may adjust the time interval in the prediction calculation unit so that the current position and the predicted position of the tracking target, or a plurality of candidate predicted positions calculated from the trajectory of the tracking target are included in the angle of view. Alternatively, the drive calculation unit may shorten the time interval in the prediction calculation unit when the error of the calculated predicted position is larger than a threshold value.

The drive calculation unit performs a drive process of setting the imaging unit in the calculated direction, and enables a moving speed of the imaging unit to the imaging direction to be changed. For example, the drive calculation unit may decrease the moving speed when the imaging direction of the imaging unit is close to the calculated direction. Alternatively, when the movement of the tracking target is stopped, the moving speed may be set to be higher than before the movement is stopped. The drive calculation unit uses the recognition result from the user recognition unit that recognizes the user who moves the tracking target to set the moving speed when the user's orientation is not the tracking target direction to be higher than when the user's orientation is the tracking target direction.

A second aspect of the present technology provides an information processing method including: allowing a prediction calculation unit to calculate a predicted position from a trajectory of a tracking target; and allowing a drive calculation unit to calculate an imaging direction of an imaging unit that images the tracking target, the imaging direction in which the predicted position is included in an angle of view of the imaging unit when the predicted position calculated by the prediction calculation unit deviates from the angle of view.

A third aspect of the present technology provides a program for allowing a computer to execute a process of setting an imaging direction of an imaging unit to a direction of a tracking target, the process comprising: calculating a predicted position from a trajectory of the tracking target; and calculating an imaging direction of the imaging unit that images the tracking target, the imaging direction in which the predicted position is included in an angle of view of the imaging unit when the calculated predicted position deviates from the angle of view.

The program of the present technology is a program that can be provided in a general-purpose computer capable of executing various program codes by a storage medium provided in a computer-readable format or a communication medium, for example, a storage medium such as an optical disc, a magnetic disk or a semiconductor memory, or a communication medium such as a network. The provision of such a program in a computer-readable format allows processing according to the program to be realized on the computer.

### BRIEF DESCRIPTION OF DRAWINGS

FIG. 1 is a diagram illustrating the basic operation of an information processing system.

FIG. 2 is a diagram illustrating the configuration of an information processing system.

FIG. 3 is a diagram showing a flow of processing in an information processing system.

FIG. 4 is a flowchart illustrating the operation of a data processing unit.

FIG. 5 is a diagram showing an operation example of the embodiment.

FIG. 6 is a diagram showing an example of movement control of the imaging direction.

FIG. 7 is a diagram showing an operation example in which the amount of calculation can be reduced.

### DESCRIPTION OF EMBODIMENTS

An embodiment for implementing the present technology will be described below.

Here, description will proceed in the following order.
1. Information processing system
2. Configuration of Embodiment
3. Operation of Embodiment
4. Other operation

<1. Information Processing System>

In recent years, an interactive projector utilization method, such as a user operating a UI (User Interface) projected by a projector, has been proposed. For example, an input operation by an operator (for example, a hand, a finger, or the like) performed at an arbitrary place in an indoor environment is sensed. In such a use case, sensing accuracy can have a significant impact on the user's input experience. Therefore, the technology of the present disclosure makes it possible to efficiently sense an input operation by a user in such a use case.

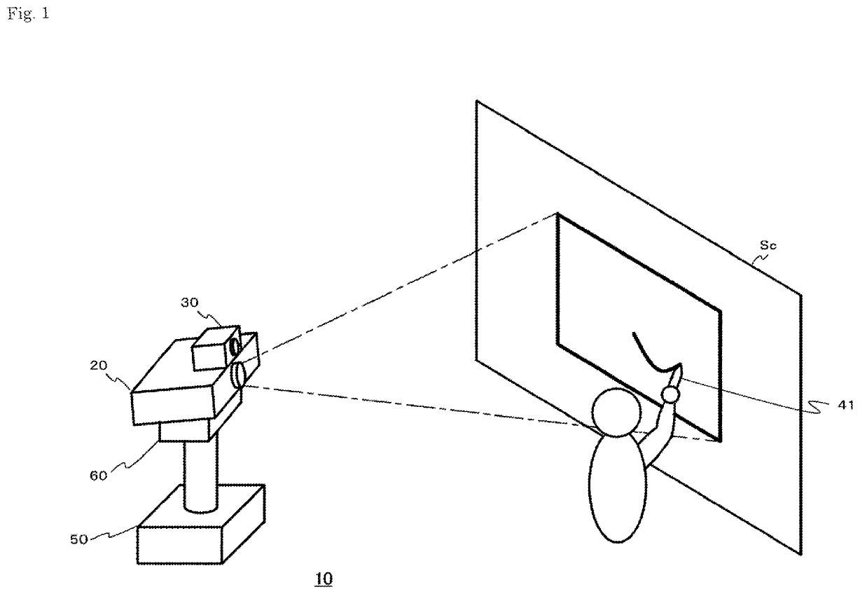

FIG. 1 is a diagram illustrating the basic operation of an information processing system using the technology of the present disclosure. In an information processing system 10, a wall surface or the like is used as a screen Sc, and a video is projected from a video output unit 20 onto the screen Sc. The screen Sc may be a floor surface, a table surface, or the like. The screen surface may be a flat surface or a curved surface. The screen Sc is also used as a pointing surface pointed to by an operator. Pointing may be realized by the contact of the operator with the screen Sc, or by the non-contact of the operator with the screen Sc. FIG. 1 illustrates a case where a pen-type device is used as an example of the operator 41. In addition, another operator (for example, a user's hand, a finger, and the like) may be used instead of the pen-type device.

The information processing unit 50 performs a process of projecting various pieces of information onto the screen Sc using the video output unit 20. The information processing unit 50 detects a drawing position from a captured image acquired by an imaging unit provided in a sensor unit 30 with the drawing position by the operator 41 on the screen Sc (image display surface) as a tracking target and displays the trajectory of the drawing position on the screen Sc based on the detection result.

The sensor unit 30 is configured so that the imaging direction of the imaging unit that images the tracking target can be moved, and the information processing unit 50 efficiently controls the imaging direction of the imaging unit according to the trajectory of the tracking target. For example, the information processing unit 50 calculates a predicted position from the trajectory of the tracking target with the drawing position indicated by the operator 41 on the screen Sc as the tracking target. The information processing unit 50 controls the imaging direction of the imaging unit so that the predicted position is included in the angle of view when the predicted position deviates from the angle of view of the imaging unit, and reduces the number of times the imaging direction of the imaging unit is changed.

### 2. Configuration of Embodiment

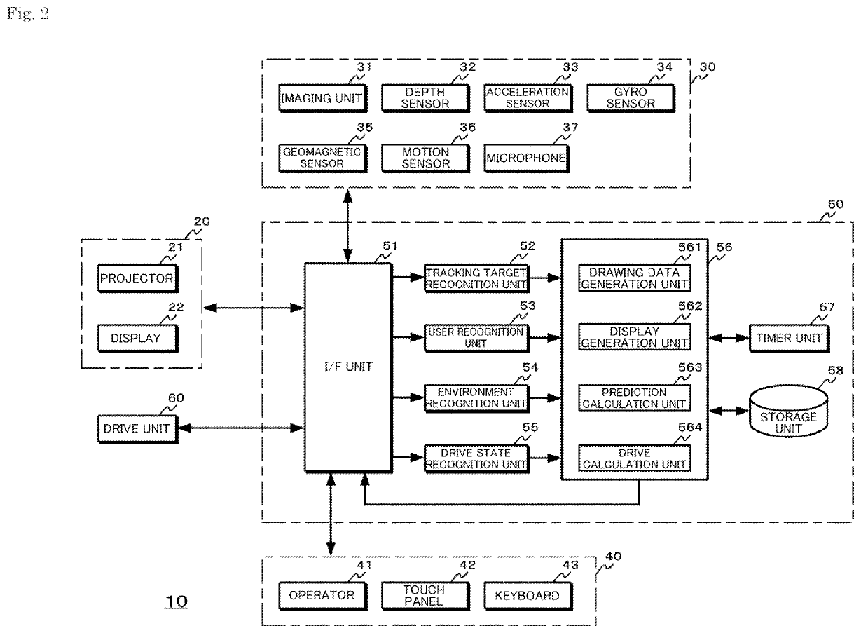

FIG. 2 is a diagram illustrating the configuration of an information processing system. The information processing system 10 includes a video output unit 20, a sensor unit 30, an operation unit 40, an information processing unit 50, and a drive unit 60.

The video output unit 20 has a projector 21 or a display 22. The projector 21 of the video output unit 20 projects a video based on the video signal output from the information processing unit 50 onto the screen Sc as shown in FIG. 1. The display 22 is configured using a liquid crystal display, an organic EL (Electro Luminescence) display, a display composed of a plurality of light emitting diodes, and the like, and displays a video based on the video signal output from the information processing unit 50 on the screen.

The sensor unit 30 has an imaging unit 31. The sensor unit 30 may include a depth sensor 32, an acceleration sensor 33, a gyro sensor 34, a geomagnetic sensor 35, a motion sensor 36, a microphone 37, and the like.

The imaging unit 31 is configured using a CMOS (Complementary Metal Oxide Semiconductor) image sensor, a CCD (Charge Coupled Device) image sensor, or the like. The imaging unit 31 performs photoelectric conversion to generate an image signal of the captured image.

The depth sensor 32 measures the distance to the subject imaged by the imaging unit 31 and generates a distance measurement signal indicating the measurement result. The acceleration sensor 33, the gyro sensor 34, and the geomagnetic sensor 35 generate sensor signals indicating the movement and attitude of the imaging unit 31. The motion sensor 36 generates a detection signal indicating a human detection result, and the microphone 37 collects surrounding sounds to generate a voice signal. The sensor unit 30 may be configured using a wearable device so that the line of sight of the user wearing the wearable device can be detected. The sensor unit 30 outputs the generated image signal, sensor signal, and image signal to the information processing unit 50.

The operation unit 40 has an operator 41. The operation unit 40 may have a touch panel 42, a keyboard 43, or the like. As the operator 41, for example, a pen-type device having an LED (Light Emitting Diode) mounted on the tip thereof is used. The pen-type device has a mechanism in which the LED emits light when pressed against the screen by the user, and the light emitting position (bright spot) by the LED is detected by the sensor unit 30.

The operator 41 may be a device to which a reflection marker is attached, or may be a device that emits directional light such as a laser pointer. Further, an acceleration sensor or a gyro sensor may be provided on the operator 41 to generate a sensor signal indicating the attitude or movement of the operator 41.

As the operator 41, a mobile terminal such as a smartphone or a bracelet-type or glasses-type wearable device may be used. For example, when the position of the device is recognized from the shape of these devices and the connection state with the computer is recognized, the position of the device and the connection state with the computer are processed in a complex manner whereby the device can also be used as an operator.

The operation unit 40 outputs, to the information processing unit 50, a sensor signal indicating the attitude and movement of the operator 41 and an operation signal generated in response to a user operation on the touch panel 42, the keyboard 43, or the like.

The information processing unit 50 includes an I/F unit 51, a tracking target recognition unit 52, a user recognition unit 53, an environment recognition unit 54, a drive state recognition unit 55, a data processing unit 56, a timer unit 57, a storage unit 58, and the like.

The I/F unit 51 is provided to electrically connect the video output unit 20, the sensor unit 30, and the operation unit 40 to the information processing unit 50.

The tracking target recognition unit 52 recognizes a tracking target located within the angle of view (in the captured image) of the imaging unit 31 based on the image signal generated by the imaging unit 31 of the sensor unit 30. The tracking target recognition unit 52 recognizes, for example, the pen-type device, which is the operator 41 or the pen tip of the pen-type device as the tracking target, and outputs the recognition result to the data processing unit 56.

The user recognition unit 53 recognizes the user who operates the operator 41, the position and orientation of the user, and the like based on the image signal and the sensor signal generated by the sensor unit 30, and outputs the recognition result to the data processing unit 56.

The environment recognition unit 54 recognizes the size of the work space and screen, the brightness of the work space, the loudness of the environmental sound, and the like based on the image signal, the sensor signal, and the voice signal generated by the sensor unit 30 and outputs the recognition result to the data processing unit 56.

The drive state recognition unit 55 recognizes the drive state of the imaging unit 31, for example, the angle of view and orientation of the imaging unit 31, based on the image signal and the sensor signal generated by the sensor unit 30, and outputs the recognition result to the data processing unit 56.

The data processing unit 56 includes a drawing data generation unit 561, a display generation unit 562, a prediction calculation unit 563, and a drive calculation unit 564.

The drawing data generation unit 561 generates drawing data based on the recognition result from the tracking target recognition unit 52. The drawing data generation unit 561 calculates a trajectory from the movement of the tracking target recognized by the tracking target recognition unit 52, for example, the movement of the pen tip of the pen-type device, and generates drawing data indicating the calculated trajectory.

The display generation unit 562 generate a display signal for outputting the video from the video output unit 20 using the information data stored in the storage unit 58 and the drawing data generated by the drawing data generation unit 561.

The prediction calculation unit 563 calculates the predicted position from the trajectory of the tracking target based on the recognition result from the tracking target recognition unit 52, and outputs the prediction result, to the drive calculation unit 564. The prediction calculation unit 563 may calculate a plurality of candidate predicted positions from the trajectory of the tracking target and calculate the predicted position based on the plurality of candidate predicted positions. For example, the prediction calculation unit 563 may calculate a plurality of predicted subsequent trajectories based on the trajectory of the tracking target, set candidate predicted positions on each predicted subsequent trajectory, and perform averaging or weighted addition of the candidate predicted positions to determine the predicted position.

The drive calculation unit 564 calculates an imaging direction of the imaging unit 31 in which the predicted position becomes a desired position within the angle of view when the predicted position calculated by the prediction calculation unit 563 deviates from the angle of view of the imaging unit 31 that images the tracking target. The drive calculation unit 564 generates a drive signal for moving the imaging direction of the imaging unit 31 in the calculated imaging direction, and outputs the drive signal to the drive unit 60.

The timer unit 57 outputs time information to the data processing unit 56 so that the elapsed time and the like can be determined.

The storage unit 58 stores display data indicating information projected on the screen Sc using the video output unit 20. The storage unit 58 stores the drawing data generated by the data processing unit 56. The display data and the drawing data may be stored in correlation so that the user operation on the display information can be reproduced.

The drive unit 60 moves the imaging direction of the imaging unit 31 of the sensor unit 30 based on the drive signal generated by the data processing unit 56 of the information processing unit 50.

The video output unit 20, the sensor unit 30, the operation unit 40, the information processing unit 50, and the drive unit 60 may be provided integrally, or only the functional blocks of any one of the units may be provided integrally. For example, the projector 21, the imaging unit 31, and the drive unit may be integrally provided, and the projection direction of the projector 21 may be moved as the imaging unit 31 moves in the imaging direction. In this case, the information projected by the projector 21 may be updated so that the display position of the information does not move even if the projection direction of the projector 21 moves.

Further, each unit may be connected via a wired transmission line, and may be connected via a wireless transmission line (for example, a transmission line conforming to standards such as Bluetooth (registered trademark) and Wi-Fi (registered trademark)).

### 3. Operation of Embodiment

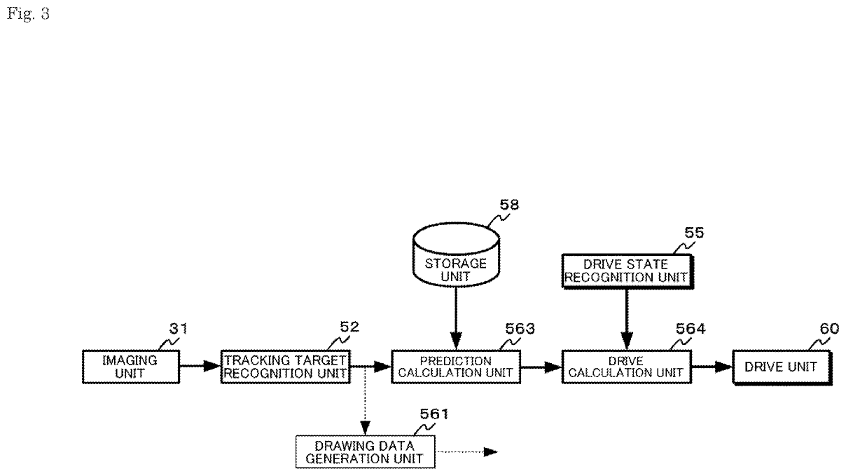

FIG. 3 shows the flow of processing in the information processing system. The imaging unit 31 generates an image signal of the captured image and outputs it to the tracking target recognition unit 52. The tracking target recognition unit 52 recognizes a tracking target included in the captured image, for example, a drawing position which is the pen tip of a pen-type device. The prediction calculation unit 563 predicts the drawing position after the lapse of a predetermined period based on the drawing position recognized by the tracking target recognition unit 52 and the trajectory data of the past drawing position stored in the storage unit 58. The drive calculation unit 564 determines whether it is necessary to move the imaging direction of the imaging unit 31 based on the imaging direction of the imaging unit 31 recognized by the drive state recognition unit 55 and the predicted position of the tracking target calculated by the prediction calculation unit 563. If it is determined that movement is necessary, the drive amount in the imaging direction is calculated. The drive unit 60 moves the imaging direction of the imaging unit 31 according to the drive amount calculated by the drive calculation unit 564, so that the imaging direction of the imaging unit 31 is moved by the drive unit 60 so that the predicted position is included in the angle of view only when the predicted position deviates from the angle of view.

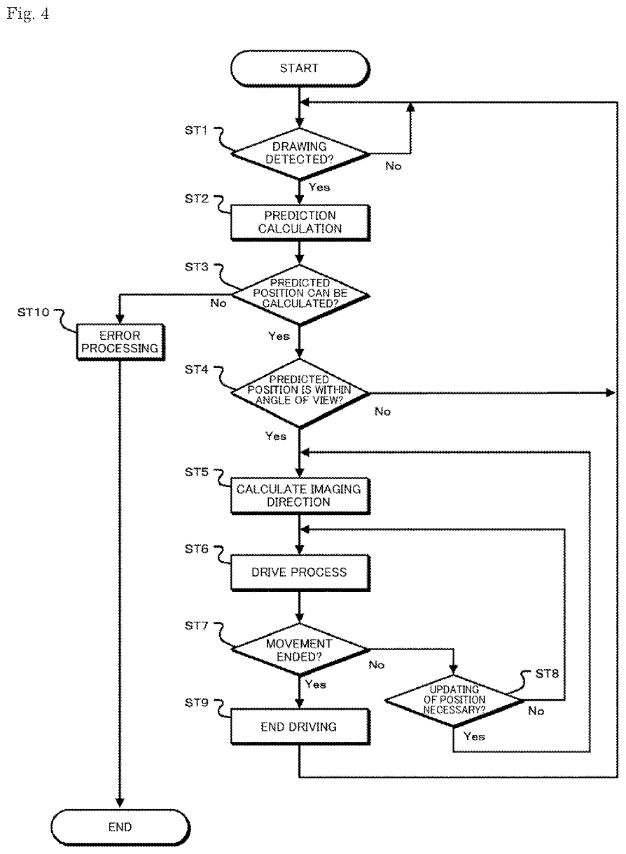

FIG. 4 is a flowchart illustrating the operation of the data processing unit. In step ST1, the data processing unit detects drawing. The data processing unit 56 detects whether or not drawing is performed based on the movement of the drawing position recognized by the tracking target recognition unit 52 from the captured image acquired by the imaging unit 31. For example, when the drawing position changes continuously, the data processing unit 56 determines that drawing is being performed and the flow proceeds to step ST2. When the drawing position does not change continuously, the data processing unit 56 determines that drawing is not performed, and the flow returns to step ST1. The drawing detection is not limited to the change in the drawing position, and other information may be used. For example, if a pen-type device equipped with an LED (Light Emitting Diode) at the tip is used as the operator 41 and the LED at the tip emits light when the pen-type device is pressed against the screen, it may be determined whether or not drawing is performed depending on whether the LED is emitting light.

In step ST2, the data processing unit performs a prediction operation. The data processing unit 56 calculates the drawing position after the lapse of a predetermined time as the predicted position based on the change in the drawing position which is the tracking target.

The data processing unit 56 predicts the trajectory of the drawing position using, for example, the method disclosed in JP 2015-72534 A. In this method, a plurality of past trajectories similar to the immediately preceding trajectory in the calculation region of the predicted trajectory are detected based on the feature amount, and the predicted subsequent trajectory is acquired for each of the plurality of detected trajectories. The predicted trajectory is calculated by averaging, weighted addition, or the like of the plurality of acquired predicted subsequent trajectories. The data processing unit 56 proceeds to step ST3 with the position after the lapse of a predetermined period in the calculated predicted trajectory as the predicted position.

In step ST3, the data processing unit determines whether the predicted position could be calculated. The data processing unit 56 proceeds to step ST4 if the predicted position can be calculated, and proceeds to step ST10 if the predicted position cannot be calculated.

In step ST4, the data processing unit determines whether the predicted position is outside the angle of view. The data processing unit 56 determines whether the predicted position calculated in step ST2 is outside the angle of view of the imaging unit 31. The data processing unit 56 proceeds to step ST5 when it is determined that the predicted position deviates from the angle of view, and returns to step ST1 when it is determined that the predicted position is within the angle of view.

In step ST5, the data processing unit calculates the imaging direction. The data processing unit 56 calculates the imaging direction of the imaging unit 31 in which the predicted position is a desired position within the angle of view, and the flow proceeds to step ST6.

In step ST6, the data processing unit performs drive processing. The data processing unit 56 generates a drive signal for moving the imaging direction of the imaging unit 31 to the imaging direction calculated in step ST5 and outputs the drive signal to the drive unit 60 so that the drive unit 60 starts moving the imaging direction to the calculated direction, and the flow proceeds to step ST7.

In step ST7, the data processing unit determines whether the movement is completed. The data processing unit 56 determines whether the imaging direction of the imaging unit 31 is the imaging direction calculated in step ST5, and if it is the calculated imaging direction, the flow proceeds to step ST9, If the imaging direction of the imaging unit 31 is not the imaging direction calculated in step ST5, the data processing unit 56 proceeds to step ST8.

In step ST8, the data processing unit determines whether it is necessary to update the position of the tracking target. When the position of the tracking target changes more than a preset threshold value, the data processing unit 56 determines that the position of the tracking target needs to be updated, and the flow returns to step ST5. Utile position of the tracking target has not changed significantly from the preset threshold value, it is determined that the position of the tracking target does not need to be updated, and the flow returns to step ST6.

When the flow proceeds from step ST7 to step ST9, the data processing unit ends the driving. Since the imaging direction of the imaging unit 31 is the imaging direction calculated in step ST5, the data processing unit 56 ends the movement of the imaging direction by the drive unit 60, returns to step ST1, and continues the process of moving the imaging direction according to the predicted position of the tracking target.

Further, when the flow proceeds from step ST3 to step ST10, the data processing unit outputs an error notification. Since the predicted position cannot be calculated, the data processing unit 56 presents the user with a notification that the imaging direction of the imaging unit 31 cannot be efficiently moved based on the trajectory of the tracking target via an image, voice, or physical operation (for example, vibration of a pen-type device) and ends the operation.

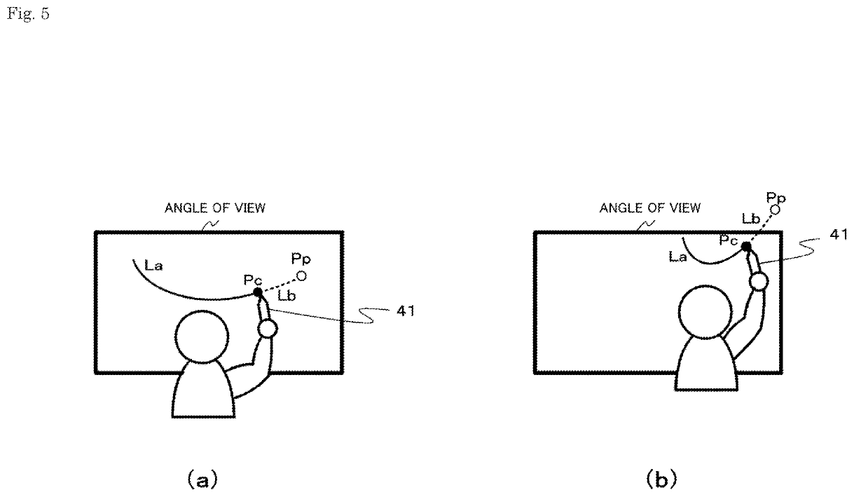

FIG. 5 shows an operation example of the embodiment. In FIG. 5, the solid line La shows the past trajectory, and the position Pc shows the current position of the tracking target (for example, the tip of the operator 41). The broken line Lb shows the predicted subsequent trajectory, and the position Pp shows the predicted position.

Here, when the predicted position Pp is within the angle of view as shown in (a) in FIG. 5, the process of moving the imaging direction of the imaging unit 31 according to the predicted position is not performed. Further, as shown in (b) FIG. 5, when the predicted position Pp is outside the angle of view, the process of moving the imaging direction of the imaging unit 31 according to the predicted position so that the predicted position is at a desired position within the angle of view is performed. Thus, the tracking target can be continuously imaged by the imaging unit 31, In this way, only when the predicted position is outside the angle of view, the process of moving the imaging direction of the imaging unit 31 according to the predicted position is performed. Therefore, for example, as compared with the case where the imaging direction is always moved so as to follow the tracking target so that the tracking target is at the center of the angle of view, the number of movements is reduced and the tracking operation can be performed efficiently. Further, when the predicted position is within the angle of view, the imaging direction of the imaging unit is fixed even if the position of the tracking target moves. Therefore, as compared with the case where the imaging direction follows the position of the tracking target, it becomes possible to detect the position of the tracking target with high accuracy, and project the trajectory data showing the trajectory of the tracking target with high accuracy on the screen.

The data processing unit 56 may set a desired position according to an imaging condition, a processing load, or the like in the process of moving the imaging direction so that the predicted position Pp is set to a desired position within the angle of view.

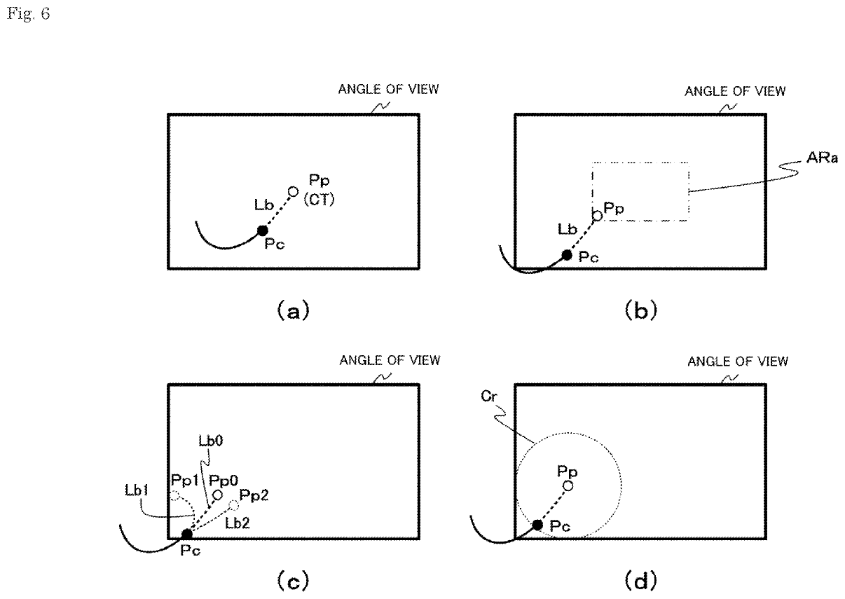

FIG. 6 shows an example of movement control of the imaging direction. In FIG. 6, the position Pc indicates the current position of the tracking target, the broken line Lb indicates the predicted subsequent trajectory, and the position Pp indicates the predicted position of the tracking target.

(a) in FIG. 6 illustrates a case where the desired position is set to the center CT of the angle of view. By setting a desired position at the center CT of the angle of view, the data processing unit 56 can arrange the tracking target in the center when the prediction accuracy is high.

(b) in FIG. 6 illustrates a case where the desired position is within a predetermined range with respect to the center of the angle of view. By setting the desired position within the range of a predetermined range ARa with respect to the center of the angle of view, the data processing unit 56 can reduce the amount of movement of the imaging direction as compared with the case where the desired position is set to the center of the angle of view.

(c) in FIG. 6 illustrates a case where a desired position in the angle of view is set to a position in which a plurality of candidate predicted positions calculated by the prediction calculation unit are within the angle of view. The prediction calculation unit 563 of the data processing unit 56 calculates the predicted positions Pp0, Pp1 and Pp2 of the predicted subsequent trajectories Lb0, Lb1 and Lb2 indicated by the broken line, for example. The drive calculation unit 564 of the data processing unit 56 sets a desired position in the angle of view to a position in which the predicted subsequent trajectories Lb0, Lb1, and Lb2 calculated by the prediction calculation unit 563 are within the angle of view. In this case, the tracking target can be imaged even when the accuracy of prediction is not guaranteed.

Further, in order to ensure reliability, when moving the imaging direction of the imaging unit, a desired position may be set so that the current position of the tracking target can be confirmed after the movement. (d) in FIG. 6 illustrates a case where the desired position is set to the current position of the tracking target and the predicted position calculated by the prediction calculation unit is set to be within the angle of view. For example, a circle Cr passing through the current position Pc of the current tracking target is calculated with the predicted position Pp as the center, and a desired position is set so that this circle Cr is included in the angle of view. Further, when the circle Cr extends beyond the angle of view, the time interval for calculating the predicted position is set to be shorter than a predetermined time interval (the number of predicted frames) to reduce the diameter of the circle Cr so that the distance from the current position Pc of the tracking target to the predicted position Pp becomes short. By doing so, it becomes possible to confirm the trajectory from the current position Pc of the tracking target to the predicted position Pp.

The time interval for calculating the predicted position may be changed within a preset range according to the prediction accuracy and the moving speed of the imaging direction, and only the predicted position with a certain accuracy or higher may be included. For example, if the position of the tracking target after Fa frames is the predicted position Pp, and the error between the predicted position Pp and the current position Pca of the tracking target when the Fa frames have elapsed is larger than a threshold value, the number of frames is reduced so that the predicted position of the tracking target after Fb (Fb<Fa) frames is used. By adjusting the time interval in this way, it is possible to reduce the error, and the imaging direction of the imaging unit 31 can be moved in an appropriate direction.

<4. Other Operation>

By the way, if the accuracy of prediction decreases due to the drawing content, processing speed, and the like, there is a concern that it may be difficult to move the imaging direction so that the tracking target is included in the angle of view. Therefore, the accuracy of the tracking operation can be improved by correcting the imaging direction in real time from the current position and predicted position of the tracking target, the position of the tracking target after the calculation of the predicted position, and the like.

When the prediction calculation unit 563 obtains the trajectory by performing averaging or weighted addition of a plurality of predicted subsequent trajectories, and the error between the current position of the tracking target and the predicted position has a certain tendency, weighting based on the tendency may be performed to determine the moving position of the imaging direction. For example, when the predicted position tends to have an error of about several pixels in the traveling direction of the trajectory, correction of several pixels which is the error amount is performed in the traveling direction. Further, this method can also be adopted when there is a certain tendency in the updating of the position of the tracking target during driving of the imaging unit 31. For example, if there is a tendency in the updating of several pixels to occur in the traveling direction of the trajectory during driving, correction of several pixels which is the update amount may be performed in advance in the traveling direction.

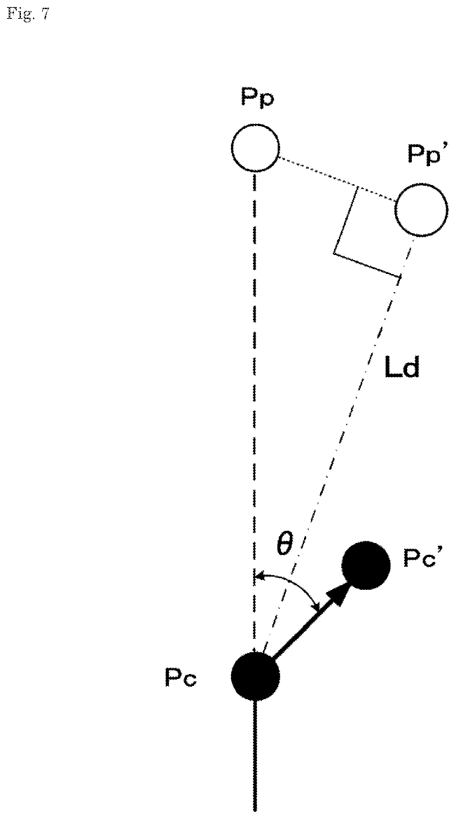

Furthermore, if the learning is updated accurately for each frame, drive correction can be performed in real time, but if the processing load is large or the delay is large, it may be difficult to calculate the predicted position at high speed. In such a case, the data processing unit 56 may perform prediction correction with a small amount of calculation. FIG. 7 shows an operation example in which the amount of calculation can be reduced. For example, the predicted position Pp is calculated when the tracking target is at the current position. Pc and a predetermined time Ta (for example, 5 frames) has elapsed. Here, when the tracking target moves from the current position Pc to the position Pc′ after the time Tb has elapsed (for example, after one frame has elapsed), the prediction calculation unit calculates the angle θ between the position Pp and the position Pc and the position Pc′ and obtains the bisector Ld of the angle θ. Next, a perpendicular line is drawn from the predicted position Pp with respect to the bisector Ld to obtain an intersection, and the intersection is set as the corrected predicted position Pp′.

In this way, the predicted position after the lapse of a predetermined time can be corrected according to the positional change of the current position before the lapse of the predetermined time, so that the accuracy of the predicted position can be ensured with a small amount of calculation without shortening the time interval for calculating the predicted position.

Further, if the user recognition result is used, the imaging direction of the imaging unit 31 can be controlled according to the user. For example, there are individual differences in the length of the hand, and when a writing operation is performed using a pen-type device, a person with a short arm has a narrower range of movement of the pen-type device than a person with a long arm. Therefore, the prediction calculation unit 563 may calculate the movable range of the pen tip according to the length of the recognized user's arm, perform the prediction calculation so that the predicted position is within the movable range, and move the imaging direction of the imaging unit 31. As the physical characteristics of the user, for example, the physical characteristics of the user determined by face recognition from the physical characteristics registered in advance for each user may be used, and the parts of the body may be determined based on the feature points detected from the captured image.

The drive calculation unit 564 may reduce the influence on drawing by adjusting the moving speed and the direction according to the distance to the predicted position and the drawing operation of the user. For example, when the distance between the current position of the tracking target and the predicted position is large, it takes time to move at a constant speed. Therefore, the drive calculation unit 564 moves the imaging direction at high speed to the vicinity of a desired position and then reduces the speed and performs fine adjustment at the desired position. Further, when the movement of the tracking target is stopped, the drive calculation unit 564 may set the moving speed to be higher than before the movement is stopped. For example, the imaging direction is moved at a low speed during drawing, and the moving speed is increased at the timing when drawing stops. In this case, the influence of the movement of the imaging direction during drawing can be reduced. Further, when the user is detected by the user recognition process, if the moving speed when the user's orientation is not the direction of the tracking target is faster than when the user's orientation is the direction of the tracking target, it is possible to prevent adverse effects caused by moving the imaging direction at the timing when the user gazes at the tracking target. For example, it is possible to prevent a situation in which, when the user is gazing at the drawing position and drawing a line, the imaging direction is moved, and the projected trajectory has an error in relation to the trajectory intended by the user due to the recognition error of the drawing position resulting from the movement of the imaging direction.

Further, by individually controlling the projection direction of the projector 21 and the imaging direction of the imaging unit 31, it is possible to efficiently move the projection direction. For example, by moving the imaging direction of the imaging unit and then moving the projection direction of the projector 21 so as to follow the imaging direction, the projection direction can be efficiently moved. Further, when the destination of the imaging direction of the imaging unit 31 is a position within the projection region of another projector, the projector that performs the projection operation may be switched to another projector. In this case, a plurality of projectors can be efficiently used.

Further, if the moving speed of the tracking target is so fast that the movement of the imaging direction of the imaging unit the imaging unit does not occur in time, and it is not possible to follow the tracking target, the user may be notified that it is not possible to follow the tracking target. For example, if the boundary of the angle of view of the imaging unit 31 is marked by the projector 21, it can be determined from the positional relationship between the boundary of the angle of view and the position of the tracking target that the imaging unit 31 cannot follow the tracking target. The notification indicating that the tracking cannot be performed may be performed not only via the image but also via voice or physical movement, for example, vibration of a pen-type device when the tracking target is the pen-type device.

In the above-described embodiment, the case where the video projected by the projector 21 is drawn by the operator is illustrated, but the operator may be moved on the screen of the display (for example, a liquid crystal display, an organic EL display, and the like) 22 to perform drawing.

The series of processing described in the specification can be executed by hardware, software, or a composite configuration of both. When the processing is executed by software, a program in which a processing sequence has been recorded is installed in a memory in a computer embedded in dedicated hardware and executed. Alternatively, the program can be installed in a general-purpose computer capable of executing various types of processing and executed.

For example, the program can be recorded in advance on a hard disk as a recording medium, an SSD (Solid State Drive), or a ROM (Read Only Memory). Alternatively, the program can be temporarily or permanently stored (recorded) in a removable recording medium such as a flexible disc, a compact disc read only memory (CD-ROM), a magneto optical (MO) disc, a digital versatile disc (DVD), a Flu-ray disc (BD) (registered trademark), a magnetic disk, or a semiconductor memory card. The removable recording medium can be provided as so-called package software.

The program may be transferred from a download site to the computer wirelessly or by wire via a network such as a local area network (LAN) or the Internet, in addition to being installed in the computer from the removable recording medium. The computer can receive the program transferred in this way and install the program in a recording medium such as a built-in hard disk.

The effects described in the present specification are merely examples and are not limited, and there may be additional effects not described. The present technology should not be construed as being limited to the embodiments of the technology described above. The embodiments of the present technology disclose the present technology in the form of examples, and it is obvious that a person skilled in the art can modify or substitute the embodiments without departing from the gist of the present technology. That is, claims should be taken into consideration in order to determine the gist of the present technology.

The information processing device of the present technology can also have the following configurations.
(1) An information processing device including: a prediction calculation unit that calculates a predicted position from a trajectory of a tracking target; and a drive calculation unit that calculates an imaging direction of an imaging unit that images the tracking target, the imaging direction in which the predicted position is included in an angle of view of the imaging unit when the predicted position calculated by the prediction calculation unit deviates from the angle of view.
(2) The information processing device according to (1), wherein the tracking target is a drawing position on an image display surface.
(3) The information processing device according to (1) or (2), wherein the drive calculation unit calculates the imaging direction of the imaging unit in which the predicted position is a desired position within the angle of view.
(4) The information processing device according to (3), wherein the drive calculation unit sets the desired position within the angle of view to a center of the angle of view.
(5) The information processing device according to (3), wherein the drive calculation unit sets the desired position within the angle of view to be within a predetermined range with respect to a center of the angle of view.
(6) The information processing device according to (3), wherein the prediction calculation unit calculates a plurality of candidate predicted positions from the trajectory of the tracking target, and the drive calculation unit sets the desired position within the angle of view to a position at which the plurality of candidate prediction positions calculated by the prediction calculation unit are within the angle of view.
(7) The information processing device according to (3), wherein the drive calculation unit sets the desired position within the angle of view to a position at which a current position of the tracking target and the predicted position calculated by the prediction calculation unit are within the angle of view.
(8) The information processing device according to any one of (1) to (7), wherein the prediction calculation unit calculates a plurality of candidate predicted positions from the trajectory of the tracking target, and calculates the predicted position based on the plurality of candidate predicted positions.
(9) The information processing device according to any one of (1) to (8), wherein the prediction calculation unit corrects the calculated predicted position according to the position of the tracking target after the predicted position is calculated.
(10) The information processing device according to any one of (1) to (9), further including: a user recognition unit that recognizes a user who moves the tracking target, wherein the prediction calculation unit corrects the calculated predicted position based on a recognition result from the user recognition unit.
(11) The information processing device according to any one of (1) to (10), wherein the prediction calculation unit can change a time interval for calculating the predicted position within a preset range.
(12) The information processing device according to (11), wherein the drive calculation unit adjusts the time interval in the prediction calculation unit so that the current position and predicted position of the tracking target or a plurality of candidate predicted positions calculated from the trajectory of the tracking target are included in the angle of view.
(13) The information processing device according to (11), wherein the prediction calculation unit shortens the time interval in the prediction calculation unit when an error of the calculated predicted position is larger than a threshold value.
(14) The information processing device according to any one of (1) to (13), wherein the drive calculation unit performs a drive process of setting the imaging unit in the calculated imaging direction, and enables a moving speed of the imaging unit to the imaging direction to be changed.
(15) The information processing device according to (14), wherein the drive calculation unit decreases the moving speed when the imaging direction of the imaging unit is close to the calculated imaging direction.
(16) The information processing device according to (14), wherein when the movement of the tracking target is stopped, the drive calculation unit sets the moving speed to be higher than before the movement is stopped.
(17) The information processing device according to (14), further including: a user recognition unit that recognizes a user who moves the tracking target, wherein the drive calculation unit sets the moving speed when a capturing direction by the user is not the direction of the tracking target to be higher than when an orientation of the user is the direction of the tracking target.

### REFERENCE SIGNS LIST

10 Information processing system
20 Video output unit
21 Projector
22 Display
30 Sensor unit
31 Imaging unit
32 Depth sensor
33 Acceleration sensor
34 Gyro sensor
35 Geomagnetic sensor
36 Motion sensor
37 Microphone
40 Operation unit
41 Operator
42 Touch panel
43 Keyboard
50 Information processing unit
51 I/F unit
52 Tracking target recognition unit
53 User recognition unit
54 Environment recognition unit
55 Drive state recognition unit
56 Data processing unit
57 Timer unit
58 Storage unit
60 Drive unit
561 Drawing data generation unit
562 Display generation unit
563 Prediction calculation unit
564 Drive calculation unit

1. An information processing device comprising:
a prediction calculation unit that calculates a predicted position from a trajectory of a tracking target; and
a drive calculation unit that calculates an imaging direction of an imaging unit that images the tracking target, the imaging direction in which the predicted position is included in an angle of view of the imaging unit when the predicted position calculated by the prediction calculation unit deviates from the angle of view.

2. The information processing device according to claim 1, wherein
the tracking target is a drawing position on an image display surface.

3. The information processing device according to claim 1, wherein
the drive calculation unit calculates the imaging direction of the imaging unit in which the predicted position is a desired position within the angle of view.

4. The information processing device according to claim 3, wherein
the drive calculation unit sets the desired position within the angle of view to a center of the angle of view.

5. The information processing device according to claim 3, wherein
the drive calculation unit, sets the desired position within the angle of view to be within a predetermined range with respect to a center of the angle of view.

6. The information processing device according to claim 3, wherein
the prediction calculation unit calculates a plurality of candidate predicted positions from the trajectory of the tracking target, and
the drive calculation unit sets the desired position within the angle of view to a position at which the plurality of candidate prediction positions calculated by the prediction calculation unit are within the angle of view.

7. The information processing device according to claim 3, wherein
the drive calculation unit, sets the desired position within the angle of view to a position at which a current position of the tracking target and the predicted position calculated by the prediction calculation unit are within the angle of view.

8. The information processing device according to claim 1, wherein
the prediction calculation unit calculates a plurality of candidate predicted positions from the trajectory of the tracking target, and calculates the predicted position based on the plurality of candidate predicted positions.

9. The information processing device according to claim 1, wherein
the prediction calculation unit corrects the calculated predicted position according to the position of the tracking target after the predicted position is calculated.

10. The information processing device according to claim 1, further comprising:
a user recognition unit that recognizes a user who moves the tracking target, wherein
the prediction calculation unit corrects the calculated predicted position based on a recognition result from the user recognition unit.

11. The information processing device according to claim 1, wherein
the prediction calculation unit can change a time interval for calculating the predicted position within a preset range.

12. The information processing device according to claim 11, wherein
the drive calculation unit adjusts the time interval in the prediction calculation unit so that the current position and predicted position of the tracking target or a plurality of candidate predicted positions calculated from the trajectory of the tracking target are included in the angle of view.

13. The information processing device according to claim 11, wherein
the prediction calculation unit shortens the time interval in the prediction calculation unit when an error of the calculated predicted position is larger than a threshold value.

14. The information processing device according to claim 1, wherein
the drive calculation unit performs a drive process of setting the imaging unit in the calculated imaging direction, and enables a moving speed of the imaging unit to the imaging direction to be changed.

15. The information processing device according to claim 14, wherein
the drive calculation unit decreases the moving speed when the imaging direction of the imaging unit is close to the calculated imaging direction.

16. The information processing device according to claim 14, wherein
when the movement of the tracking target is stopped, the drive calculation unit sets the moving speed to be higher than before the movement is stopped.

17. The information processing device according to claim 14, further comprising:
a user recognition unit that recognizes a user who moves the tracking target, wherein
the drive calculation unit sets the moving speed when an orientation of the user is not the direction of the tracking target to be higher than when the orientation of the user is the direction of the tracking target.

18. An information processing method comprising:
allowing a prediction calculation unit to calculate a predicted position from a trajectory of a tracking target; and
allowing a drive calculation unit to calculate an imaging direction of an imaging unit that images the tracking target, the imaging direction in which the predicted position is included in an angle of view of the imaging unit when the predicted position calculated by the prediction calculation unit deviates from the angle of view.

19. A program for allowing a computer to execute a process of setting an imaging direction of an imaging unit to a direction of a tracking target, the process comprising:
calculating a predicted position from a trajectory of the tracking target; and
calculating an imaging direction of the imaging unit that images the tracking target, the imaging direction in which the predicted position is included in an angle of view of the imaging unit when the calculated predicted position deviates from the angle of view.
